(19) United States
(12) Patent Application Publication
(10) Pub. No.: US 2008/0251011 A1
(43) Pub. Date: Oct. 16, 2008

(54) Device for Coating, in Particular for Painting Objects, in Particular Vehicle Bodies

(76) Inventor: Markus Albrecht, Abstatt (DE)

Correspondence Address: Michael D Lake;Factor & Lake, 1327 W Washington Blvd, Suite 5G/H, Chicago, IL, 60607, US

(21) Appl. No.: 11/660,233

(22) PCT Filed: Jul. 8, 2005
(86) PCT No.: PCT/EP05/07391

§ 371 Date: Feb. 8, 2008

(30) Foreign Application Priority Data
Aug. 19, 2004 (DE) 10 2004 040 161.6

(51) Int. Cl. B05C 13/00

(52) U.S. Cl. 118/500

(57) ABSTRACT

The invention relates to a device for coating, in particular, for painting objects, in particular, vehicle bodies, comprising a multi-axis robot supporting an application device. Said robot is secured to a carriage which can be guided in an essentially linear manner along the guide structure. The guide structure comprises a carrier element which extends over the displacement path of the robot and which receives the force. A guide rail is arranged on the top side of the carrier element, said guide rail co-operating with a complementary linear guide of the carriage. A support rail which is arranged on a lateral surface of the carrier element tilts, whereon at least one guide roller of the carriage unrolls. Said support element is embodied as a hollow profile which is strengthened on at least one side by means of a plurality of reinforcing ribs in order to reduce the costs and the weight of the carrier element.

The invention relates to a device for coating, in particular for painting objects, in particular vehicle bodies, comprising:
a) a multi-axis robot which supports an application device;
b) a carriage which supports the robot and is displaceable in a substantially linear manner;
c) a guide structure along which the carriage is displaceable and which comprises:
   ca) a support element which absorbs the forces concerned and extends over the displacement travel of the robot;
   cb) a guide rail arranged on the upper side of the support element and cooperating with a complementary linear guide of the carriage;
   cc) a support rail arranged on a side face of the support element, on which support rail at least one guide roller of the carriage runs.

Multi-axis robots which support an application device for the coating medium, for example, a paint spray gun, are used for the fully automatic painting, or otherwise coating, of objects such as vehicle bodies. Their multi-axis configuration enables them to follow precisely the contour of the object to be coated while respecting certain criteria. These criteria include maintaining a given distance from the object to be coated and orienting the spray jet, for example, in such a way that the latter always impinges perpendicularly on the surface to be coated.

In automated production the objects to be coated are generally moved linearly or intermittently through the coating cabin by means of a conveyor device. If the movement of the object takes place continuously it is necessary for the robot to follow the movement of the object during the painting process. In the case of objects which are stationary during the coating process and are comparatively long, it is also frequently expedient if the robot is able to execute a linear movement in addition to its normal total of generally six axes. This linear motion capability is also called the “seventh axis” in specialised circles.

In known commercially available devices of the type mentioned in the introduction the support element, which must absorb quite considerable forces and—because the robot projects into the coating cabin from the side—must also absorb tilting moments, is formed by a solid profile. This is, however, extremely heavy and therefore costly and difficult to handle.

It is the object of the present invention so to configure a device of the type mentioned in the introduction that it is, overall, less costly and simpler to erect on site. This object is achieved according to the invention in that
d) the support element is formed by a hollow profile which is stiffened on at least one side by a plurality of reinforcing ribs.

According to the invention the solid profile used hitherto as the support element is replaced by a hollow profile, the weight of which is understandably very much lower than that of the solid profile. In order nevertheless to achieve the required mechanical strength of the support element, the hollow profile is additionally stiffened from the side by reinforcing ribs. The hollow profile according to the invention is not only very much less costly than the known support element but can be installed on the site with simpler means, in particular in cases when no overhead crane is available or when the installation site cannot be reached by an overhead crane.

The hollow profile is expediently stiffened by a plurality of reinforcing ribs on both opposed lateral faces.

The embodiment of the device in which the hollow profile is composed from a plurality of segments arranged end-to-end is especially preferred. The length of each segment is so selected that it is easily handled during transportation to the site and during installation because of its dimensions and weight.

A handling robot may additionally be displaceable on the guide structure. Such handling robots are used, for example, to swivel doors and other moving parts of vehicle bodies during painting, so that all surface areas can be reached by the paint.

An embodiment of the invention is explained in more detail below with reference to the drawings, in which:

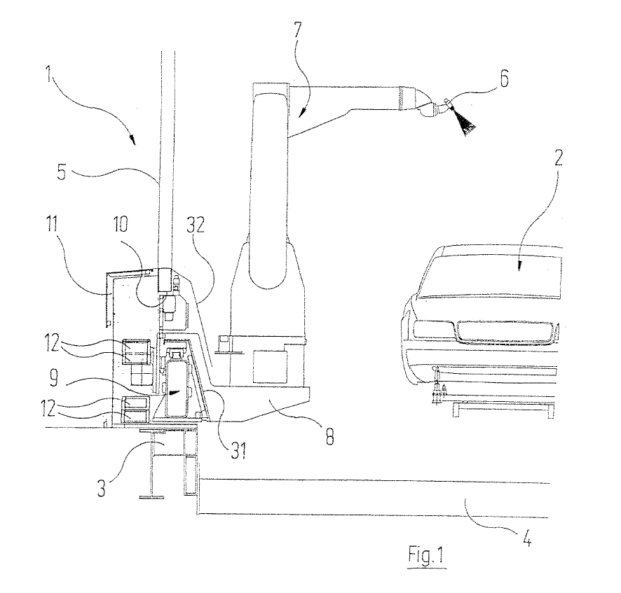

FIG. 1 shows a partial section through a paint spray cabin for painting vehicle bodies;

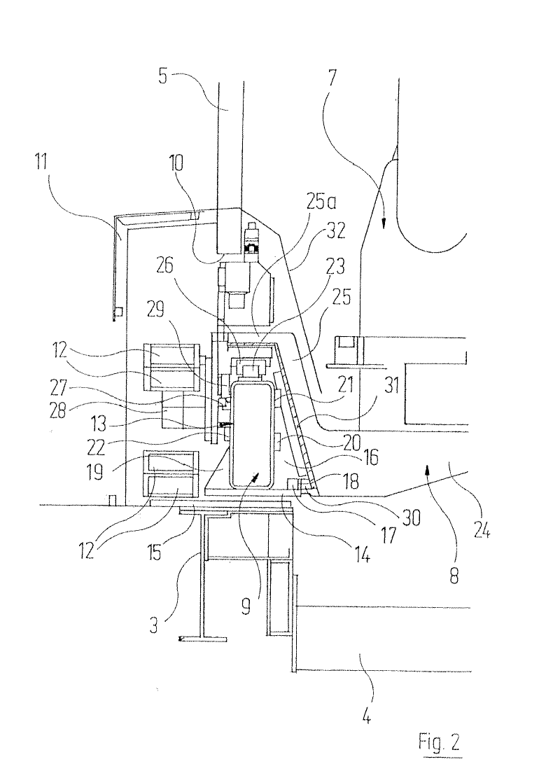

FIG. 2 shows an enlarged detail from FIG. 1.

In FIG. 1 a paint spray cabin as used for painting vehicle bodies 2 is denoted as a whole by reference 1. It is supported by a steel structure of which a horizontal beam 3 can be seen in the drawing. The paint spray cabin 1 is delimited at the bottom by a floor structure 4 (not of further interest here), on each side by side walls 5 which may be transparent, and at the top by a roof structure (not shown and likewise not of interest here). The vehicle bodies 2 are moved continuously or intermittently through the cabin by a conveyor system (not shown) in a direction perpendicular to the drawing plane of the Figure, while being painted in the manner described below.

The painting of the vehicle bodies 2 is carried out by means of a spray gun 6 which is guided by a six-axis robot denoted as a whole by reference 7. The robot 7 is in turn mounted on a carriage 8 which is displaceable along a guide structure 9, explained in more detail below, parallel to the direction of motion of the vehicle bodies 2, that is, along the adjacent side wall 5.

A side-housing 11, in which are housed various components required for supplying and operating the carriage 8 and the robot 7, is attached to the lower portion of each side wall 5 and is connected to the interior of the paint spray cabin 1 via a wide slot-like access opening 10. Said components are, in particular, electric and pneumatic control systems, valves, electric lines and supply lines for delivering paint and compressed air (all not illustrated), and media guide chains 12a, 12b. Four sections of these media guide chains 12a, 12b are represented. Retained thereon are the various electric and media-carrying connecting lines which are guided in a loop from a fixed connection point in the region of the side-housing 11 to the carriage 8 and the robot 7 mounted thereon.

In describing the guide structure 9 along which the carriage 8 with the robot 7 is moved, reference will now be made to the enlarged detail shown in FIG. 2. As can be seen from this Figure, the guide structure 9 comprises as its main load-bearing component a hollow profile 13 which is commercially available as a standard part. The hollow profile 13 has a substantially rectangular cross-section, the long sides of the rectangle being disposed vertically. The lower short side of the hollow profile 13 is fixed to a horizontal support plate 14 which in turn is connected adjustably with regard to height and orientation to a sub-plate 15 fixed to the steel structure 3 by screws (not shown).

Stiffening profile ribs 16 which in the side view of FIG. 2 have approximately the shape of a right-angled triangle are welded at regular intervals to the lateral face of the hollow profile 13 oriented towards the interior of the cabin. A guide rail 17, which is fixed to the support plate 14 and has a hardened track 18 on its side face oriented towards the interior of the paint spray cabin 1, is disposed between the stiffening profile ribs 16.

The hollow profile 13 is also provided at regular intervals on its side face oriented away from the interior of the paint spray cabin 1 with stiffening ribs 19 which are triangular when viewed in elevation.

Viewed longitudinally, that is, perpendicularly to the drawing plane of FIGS. 1 and 2, the hollow profile 13 consists of individual segments the lengths of which are such that the individual segments can be easily handled. These segments are held together by flat steel strips 20, 21 which extend over the full length of the guide structure 9 and are welded to the inner lateral face of the hollow profile 13, and by a flat steel strip 22 which also extends over the full length of the guide structure 9 and is welded to the outer lateral face of the hollow profile 13.

On its upper short side the hollow profile 13 carries a profile guide rail 23 which preferably extends over all or at any rate a plurality of the segments of the hollow profile 13.

The carriage 8 includes a platform 24 which projects into the interior of the cabin and is so configured that it can support different makes of robots 7. Two extension arms 25, which are connected to the platform and are so formed that they extend around the guide structure 9 from the side and from above, each carry, in their region 25a located above the hollow profile 13 and disposed substantially horizontally, a linear guide 26 which is displaceable with low friction on the profile guide rail 23.

A horizontally disposed, obliquely toothed rack 27 is mounted on the outwardly-oriented lateral face of the hollow profile 13; said rack also extends preferably over the full length of the hollow profile 13, or at least over a plurality of its segments.

The carriage 8 carries a drive motor the gearbox 28 of which can be seen in the drawing and the output pinion 29 of which meshes with the rack 27.

A plurality of guide rollers 30 which can run on the hardened track 18 of the guide rail 17 are mounted rotatably about vertical axes in the lowest region of the carriage 8.

The whole guide structure 9 is protected on its side facing inwards and upwards by a sheet metal cover 31 which at the same time prevents contaminants such as paint mist from entering the interior of the side-housing 11. A further sheet metal cover 32 is fixed by its upper edge to the inner side of the cabin wall 5 above the slot-like access opening 10, and extends so far down that it laterally overlaps the lower sheet metal cover 31. To prevent dirt from entering the side-housing 11 through the gap between the two sheet metal covers 31, 32, the interior of the side-housing 11 is maintained at a higher pressure than the interior of the paint spray cabin 1.

During operation of the above-described paint spray cabin 1 the vehicle bodies 2, as described above, are moved intermittently or continuously perpendicularly to the drawing plane of FIGS. 1 and 2, for example, upwardly. During this movement or while at a standstill the vehicle bodies 2 are coated with the aid of the paint spray gun 6 which, using the seven axes of the robot 7, is moved in such a way that all regions of the vehicle body 2 which are to be painted are reached, the most favourable distance between spray gun 6 and vehicle body 2, and the most favourable orientation of the paint mist, being adjusted. As this happens the robot 7 may be moved along its “seventh axis” predefined by the guide structure 9, either in order to paint along a stationary vehicle body 2 in a horizontal direction, or to follow a moving vehicle body 2.

1. A device for coating objects, comprising:
a multi-axis robot which supports an application device;
a carriage which supports the robot and is displaceable in a substantially linear manner;
a guide structure along which the carriage is displaceable and which comprises:
a support element which absorbs the forces concerned and extends over the displacement travel of the robot;
a guide rail arranged on the upper side of the support element and cooperating with a complementary linear guide of the carriage; and,
a support rail arranged on a side face of the support element, on which support rail at least one guide roller of the carriage runs, wherein
the support element is formed by a hollow profile which is stiffened on at least one side by a plurality of reinforcing ribs.

2. The device of claim 1, wherein the hollow profile is stiffened on both opposed lateral faces by a plurality of reinforcing ribs.

3. The device of claim 2, wherein the hollow profile is composed from a plurality of segments arranged end-to-end.

4. The device of claim 1, wherein a handling robot is additionally displaceable on the guide structure.

5. The device of claim 2, wherein a handling robot is additionally displaceable on the guide structure.

6. The device of claim 3, wherein a handling robot is additionally displaceable on the guide structure.

7. The device of claim 1, wherein the hollow profile is composed from a plurality of segments arranged end-to-end.
